(19) United States
(12) Patent Application Publication
(10) Pub. No.: US 2014/0376678 A1
(43) Pub. Date: Dec. 25, 2014

(54) Method of and Apparatus for Monitoring a Nuclear Reactor Core Under Normal and Accident Conditions

(71) Applicant: Robert H. Leyse, Sun Valley, ID (US)

(72) Inventor: Robert H. Leyse, Sun Valley, ID (US)

(21) Appl. No.: 13/926,436

(22) Filed: Jun. 25, 2013

(51) Int. Cl. G21C 17/112

(52) U.S. Cl. CPC G21C 17/112
USPC 376/247

(57) ABSTRACT

A system is provided which employs in-core thermocouples for determining the condition of a water cooled nuclear reactor core, especially monitoring the progress of degradation of the nuclear reactor core during various accidents. A water cooled and moderated nuclear reactor core includes tons of zirconium alloy structures. During various accidents these structures become overheated and exothermic chemical reactions between the zirconium alloy structures and the water lead to accelerated destruction of the nuclear reactor core. The very severe accidents at Three Mile Island Unit-2 during April 1979 and the Fukushima units in Japan during March 2011 were unforeseen and instrumentation was not in place to monitor the course of those accidents. Timely data on the initiation and progress of the degradation of a nuclear reactor core is provided with the inventor's apparatus and his methods of using of the apparatus regardless of the path of an accident.

This invention relates generally to core damage monitoring and more particularly to in-core thermocouples for monitoring the progress of the degradation of any water cooled nuclear reactor core during various accidents.

### BACKGROUND OF THE INVENTION

The primary concern in initiating evacuations of the public from the vicinity of a nuclear power plant in the event of any one of an assortment of accidents is the condition of the reactor core. For example, during the accidents at the Fukushima boiling water nuclear power reactors during March 2011, there was no workable means of inferring the condition of the reactor cores as the accidents progressed.

In the art, it has been the practice to infer the condition of the core from external measurements of pressure, temperature and the liquid level in the core. Measurement of the liquid level in the core has proven to be unreliable in the course of accidents such as Fukushima. Inferring the condition of the core from external measurements such as the temperature of the fluid above the core has also proven to be unsatisfactory. Clearly, there is a need for a direct means to determine the condition of the reactor core during an assortment of accidents including severe accidents.

### SUMMARY OF THE INVENTION

In view of the above need, it is an object of this invention to provide a method for continuous monitoring of the condition of the reactor core.

Another object of the invention is to provide a method of monitoring the condition of a nuclear reactor core which does not require the utilization of additional space within the reactor core.

Other objects, advantages, and novel features of the invention will be set forth in part, in the description which follows, and in part, will become apparent to those skilled in the art upon examination of the following or may be learned by practice of the invention.

To achieve the foregoing and other objects and in accordance with the purpose of the present invention, as embodied and broadly described herein, the method of monitoring, analyzing, recording and responding to the condition of the reactor core during normal operating conditions or during an assortment of impending or progressing severe accident conditions, comprises several thermocouples or other temperature sensing means disposed within the nuclear reactor core. The temperatures throughout the core are thus continuously monitored and reported to the operators of the nuclear power plant. Departures from normal conditions thus become immediately apparent and the operators are enabled to respond accordingly.

### BRIEF DESCRIPTION OF THE DRAWINGS

The accompanying drawings, which are incorporated in and form a part of the specification, together with the description, serve to explain the principles of the invention. In the drawings:

FIG. 1 is a view of a nuclear reactor core illustrating the dispersion of in-core thermocouple locations among the fuel rods.

FIG. 2 is a section view along line 2-2 of FIG. 1.

FIG. 3 is a view of one thermocouple assembly.

FIG. 4 is a view of an in-core thermocouple within a gamma thermometer.

FIG. 5 is a view of a nuclear reactor core illustrating the incorporation of in-core thermocouples within current installations of other in-core instruments.

FIG. 6 is a set of plots that describe the axial distribution of power at the start, midpoint and end of a typical operating cycle for a boiling water reactor. The set of plots is copied from a design control document.

FIG. 7 shows the display of in-core thermocouples.

FIG. 8 shows the incorporation of in-core thermocouples into the existing monitoring equipment at nuclear power plants; the Safety Parameter Display System (SPDS).

### DETAILED DESCRIPTION OF THE INVENTION

The following descriptions refer to boiling water reactors and pressurized water reactors that produce electric power; however, this invention is not restricted to those types of reactors. There are other less common nuclear reactors; test reactors with assorted applications, liquid metal cooled reactors in various stages of development, and assorted other nuclear reactors.

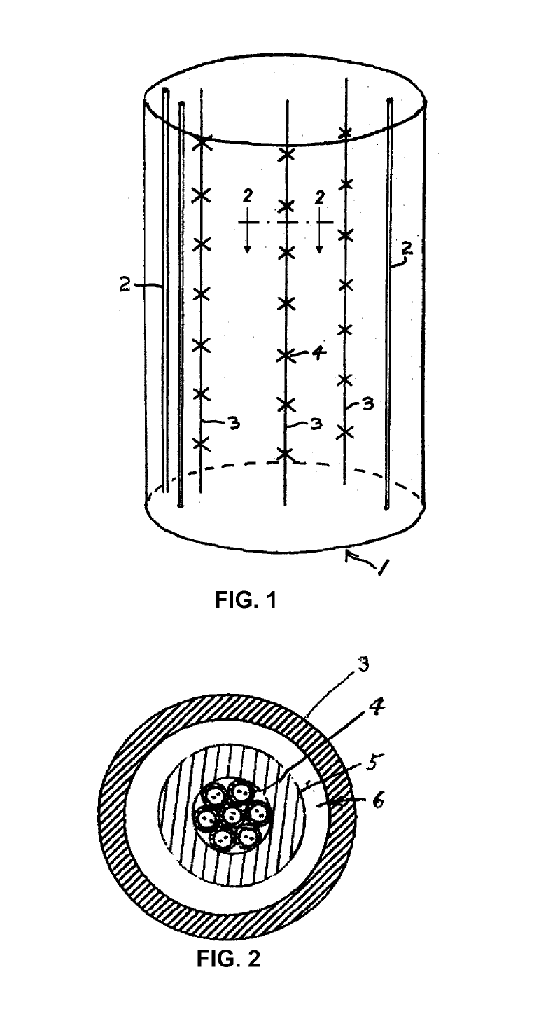

In FIG. 1, the number 1 designates the nuclear reactor core which consists of series of vertical nuclear fuel rods 2 held in positions by open mechanical supports. Several instrumentation tubes 3 are installed among the fuel rods. Instrument rods 5 are installed within these instrument tubes and an instrument rod is identified in the section view FIG. 2. Each instrument rod contains several in-core thermocouples along the length as indicated by the symbol X in FIG. 1 and identified as 4.

FIG. 2 is a section view from FIG. 1 of an instrumentation tube 3 and its instrument rod 5 which houses several in-core thermocouples 4. The heat produced in the instrument rod 5 is removed by coolant flow in the flow passage 6.

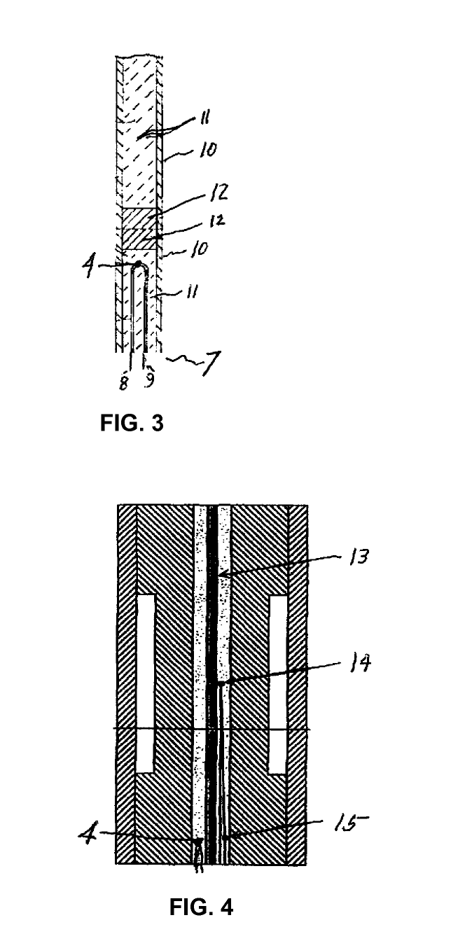

FIG. 3 is a view of thermocouple assembly 7 in greater detail. Thermocouple junction 4 is formed by the junction of dissimilar metal wires 8 and 9. The voltage signal from wires 8 and 9 represents the temperature at junction 4. This assembly 7 includes a containing tube 10 and ceramic electrical insulating material 11 and an end cap 12. In order to preserve the constant cross section shown in FIG. 2, along the length of the instrument rod 5, it is common practice to add a “dummy” ceramic filled section as shown in FIG. 3 to complete the length above the monitored temperature. This is commonly achieved by welding together the two end caps 12.

An expedient means of installing the in-core thermocouples that are necessary for implementing my method of monitoring the progress of the degradation of a nuclear reactor core during various accidents is to incorporate the thermocouples within assemblies that are already in use for monitoring other aspects of core performance.

The report by GE Hitachi Nuclear Energy, Gamma Thermometer System for LPRM Calibration and Power Shape Monitoring, NEDO-33197-A, October 2010, and an earlier version by GE Nuclear Energy, NEDO-33197, September 2005, document the set of in-core monitors that are installed in boiling water reactors. These in-core monitors are called gamma thermometers and they may be conveniently modified to incorporate the in-core thermocouples that are required to implement the methods of this invention. The current GE Hitachi system consists of 64 assemblies with 7 gamma thermometers per assembly. It is feasible to install additional thermocouples among the array of 448 gamma thermometers for measurement of the local temperature at selected locations; however it is not necessary to install the additional thermocouples in all of the gamma thermometer assemblies.

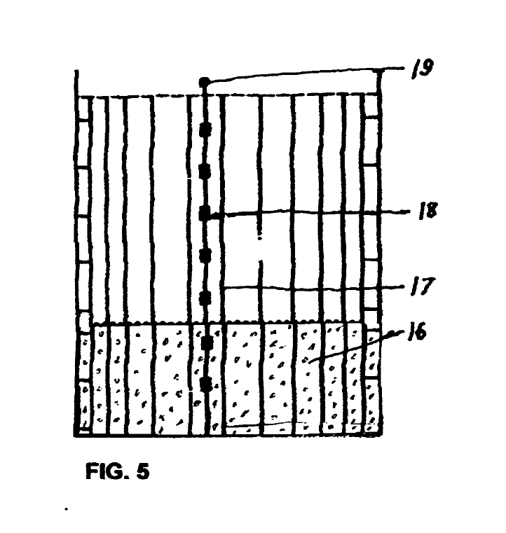

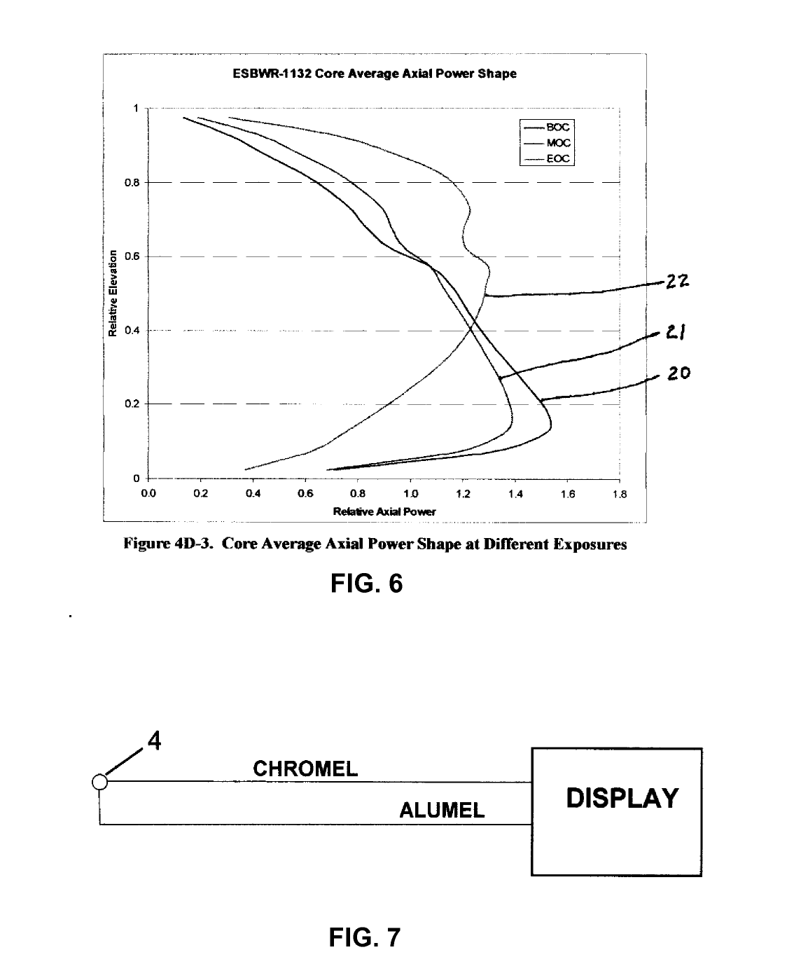

One embodiment of my invention is the measurement of the absolute temperature within several gamma thermometers. FIG. 4 shows one of several gamma thermometers that are normally arrayed along a length of rod which occupies an assigned location in a Boiling Water Reactor or Pressurized Water Reactor core. In one embodiment of this invention several gamma thermometers are modified so that an absolute temperature is measured within each. This is achieved by adding thermocouple junction 4 within the gamma thermometer. Thermocouple junction 4 is in FIG. 1 indicated by the symbol X and identified as 4. Other aspects of the gamma thermometer are not new to this invention; these are the core heater 13, and a differential thermocouple assembly consisting of a hot junction 14 and a colder junction 15. The thermocouple 4 within FIG. 4 effects the improvement of the gamma thermometer assembly by serving as an in-core thermocouple. This invention thus includes the combination of existing gamma thermometer art with the addition of the in-core temperature measurement, thermocouple 4. In this embodiment, the in-core thermocouple is placed within the gamma thermometer assembly.

Another embodiment of my invention is to install the in-core thermocouples within in-core instrument thimbles that are state-of-the-art in pressurized water reactors. In this case the thermocouple junctions 4 of FIG. 1 are installed within the existing designs of in-core instrument thimbles by substituting a limited number of the existing detectors with in-core thermocouples. FIG. 5 is a view of a pressurized water reactor core under accident conditions with the core only partially filled with water 16. For this paragraph the relevance is not the fact that the core is under accident conditions and only partially covered with water. For clarification, I am also referring to the relation between FIG. 1 and FIG. 5 so I am repeating FIG. 1 and placing it adjacent to FIG. 5. In FIG. 5, one of about fifty in-core instrument thimbles 17 is illustrated within a nuclear reactor core. These in-core instrument thimbles 17 correspond to the instrumentation tubes 3 of FIG. 1. These in-core instrument thimbles 17 are surrounded with nuclear fuel rods as is illustrated by item 2 in FIG. 1, however this is not illustrated in FIG. 5. The seven self powered neutron detectors 18 are spaced vertically within the instrument tube and within the nuclear core. The sheathed thermocouple 19 is located above the nuclear reactor core and is commonly known as the core exit thermocouple. Typically, there are about fifty such core exit thermocouples. In one embodiment of my invention the sheathed thermocouple 19 is located within the nuclear reactor core, in which case it becomes an in-core thermocouple and is identified as an in-core thermocouple 4 in FIG. 1. An alternate embodiment is to replace the position of one or more of the seven self powered neutron detectors 18 with one or more in-core thermocouples 4. The in-core thermocouples in this case are constructed as in FIG. 3 in order to preserve the constant cross section over the length of the assembly.

Having described the apparatus for installation of in-core thermocouples, I will now move to the method of their use in monitoring the condition of a nuclear reactor core under normal operating conditions as well as monitoring the progress of degradation of a water cooled and moderated nuclear reactor core during various accidents.

With a set of thermocouples located within a nuclear reactor core; a set of temperatures is measured, displayed, monitored by the operators of the nuclear power plant, continuously recorded, and automatically monitored. In the event of a severe accident, in-core thermocouples would enable nuclear power plant operators to monitor in-core temperatures, providing crucial information to enable the plant operators track the progression of core damage. This is a capability that is not available to plant operators within the current state of the art. It is a capability that would have been extremely useful during the severe nuclear plant accidents at Fukushima, Japan during March 2011.

Regarding the existing state of the art for monitoring nuclear reactor cores under the transient conditions that lead to severe accidents as well during the severe accidents; in the following paragraph from the U. S. Nuclear Regulatory Commission (NRC) April 2012 Federal Register notice for a proposed rulemaking, regarding onsite emergency response capabilities, NRC asks stakeholders:
What is the best approach to ensure that procedural guidance for beyond design basis events is based on sound science, coherent, and integrated? What is the most effective strategy for linking the Emergency Operating Procedures (EOPs) with the Severe Accident Management Guidelines (SAMGs) and Extreme Damage Mitigation Guidelines (EDMG)? Should the transition from EOPs to SAMGs be based on key safety functions, or should the SAMGs be developed in a manner that addresses a series of events that are beyond a plant's design basis?

The Nuclear Energy Institute (NEI), representing the nuclear power plant operators in the U.S.A. responded to NRC's questions. NEI referenced an Electric Power Research Institute document, Severe Accident Management Guidance Technical Basis Report, December 1992, EPRI TR-101869 (EPRI TBR). Among other statements in NEI's response, NEI answered:
T]he EPRI TBR, in conjunction with many other source documents such as NRC documents (NUREGs), provides a sound scientific foundation, and this is supplemented in application by insights from the plant probabilistic risk assessment (PRA)] and other plant-specific information. There are currently well defined transitions from the EOPs, which are focused on preventing core damage, to the SAMGs, which are focused on protecting fission-product boundaries once it is determined that core damage cannot be prevented . . . .
A transition from an EOP to a SAMG should be symptom-based; i.e., based upon control room receipt of specific parameter values that directly indicate incipient core damage. The transition is clear and is reinforced through training. This symptom-based approach, which is independent of the initiating event, is currently used by the industry and should be maintained.

However, the reviewers of the 1992 EPRI TBR that is cited by NEI caution its users as follows:

Because instrumentation is, in many cases, plant specific, it was decided by the reviewers that the role of instrumentation in severe accidents will be addressed by the nuclear power plant owners' groups. For that reason, the TBR does not address the use of instrumentation during severe accidents to infer the course of a given accident or to choose among candidate mitigative actions; rather, the focus is on symptoms. Users of the TBR should rely upon applicable and available instruments that can be used to determine the status of accident progression, and the effects of implementing accident management guidance. Instrument feedback can be used to compensate for the lack of knowledge and uncertainty in severe accident phenomena.

Clearly, the EPRI TBR does not address the use of instrumentation during severe accidents and the NEI remarks tell us nothing about the state of the art. The most recent documentation of the state of the art comes from Westinghouse A Toshiba Group Company (Westinghouse). Westinghouse advertises its AP1000 nuclear power plant a “ . . . the most advanced design available in the global marketplace.”

In the Westinghouse probabilistic risk assessment for the AP1000, Westinghouse defines two of the time frames that would occur in a severe accident: Time Frame 1 is the Core Heatup Phase and Time Frame 2 is the In-Vessel Severe Accident Phase. Westinghouse states that “Time Frame 1 is defined as the period of time after core uncovery and prior to the onset of significant core damage as evidenced by the rapid zirconium-water reactions in the core. This is the transition period from design basis to severe accident environment.” Regarding Time Frame 2, Westinghouse states that “[t]he onset of rapid zirconium-water reactions of the fuel rod cladding and hydrogen generation defines the beginning of Time Frame 2. The heat of the exothermic reaction accelerates the degradation, melting, and relocation of the core.”

Westinghouse's probabilistic risk assessment for the AP1000 states that the core-exit gas temperature (CET) would reach 1200° F. in Time Frame 1, before the onset of the rapid zirconium-steam reaction of the fuel cladding.

In a different Westinghouse document, from 2008, Westinghouse states that “an inadequate core cooling condition is assumed in the [Westinghouse Owners Group emergency response guidelines] if the highest reading CETs are indicating greater than 1200 degrees F.” Therefore, according to Westinghouse, CET readings of 1200° F. are a primary symptom of an inadequate core cooling condition.

The U.S. nuclear industry and NRC both assume that CET readings of 1200° F. are a primary symptom of an inadequate core cooling condition. (For example, in July 2011, the NRC's Near-Term Task Force, established in response to the Fukushima Dai-ichi Accident, stated that “EOPs typically cover accidents to the point of loss of core cooling and initiation of inadequate core cooling (e.g., core exit temperatures in PWRs greater than 649 degrees Celsius (1200 degrees Fahrenheit)).”

Westinghouse certainly believes that CETs are essential instrumentation. In a 2008 document, Westinghouse states:
The new core damage assessment methodology relies solely on instrumentation to determine the occurrence of and degree of core damage. The methodology uses two primary indicators, based on the analytical modeling of a wide range of core damage accidents: 1) CETs and 2) containment radiation.

And in the same 2008 document, Westinghouse states:
The CET indication provides the most direct and unambiguous indication of the potential loss of fuel rod clad barrier . . . .
The loss of fuel rod clad barrier will always be indicated first by high CET indications. Containment and [reactor coolant system] letdown radiation levels will always lag the CET temperatures and may be useful only to confirm the loss of the fuel rod clad barrier. The issue with the radiation monitors is that a pathway must exist for the fission products to reach the volume being monitored for high radiation levels.

In fact. Westinghouse has “concluded that only the CETs can provide a direct indication of core cooling.” However, the experimental data discussed below indicates that CET readings would be inadequate for providing information to help plant operators initiate crucial accident management actions.

NRC and the U.S. nuclear industry do not acknowledge that there is experimental data from tests conducted at several facilities indicating that CET measurements would not be an adequate indicator for when to transition from EOPs to implementing SAMGs in a severe accident.

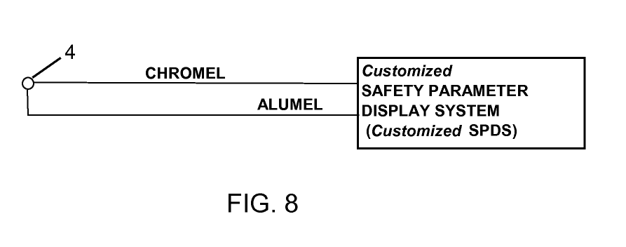

In a Pressurized Water Reactor (PWR) severe accident, CET readings would be used to signal the point for plant operators to transition from EOPs to implementing SAMGs. FIG. 8 shows the incorporation of in-core thermocouples into the existing monitoring equipment at nuclear power plants, the Safety Parameter Display System (SPDS).

However, there is experimental data from tests conducted at several facilities indicating there would be significant deficiencies in relying on CET readings in the event of a severe accident. Robert Prior, et al., OECD Nuclear Energy Agency, Committee on the Safety of Nuclear Installations, “Core Exit Temperature (CET) Effectiveness in Accident Management of Nuclear Power Reactor,” NEA/CSNI/R(2010)9, Nov. 26, 2010, report several conclusions that are based on the evaluation of several independent experiments. Here are selected conclusions:
The use of the CET measurements has limitations in detecting inadequate core cooling and core uncovery.
The CET indication displays in all cases a significant delay (up to several 100 [seconds]).
The CET reading is always significantly lower (up to several 100 [Kelvin]) than the actual maximum cladding temperature. CET performance strongly depends on the accident scenarios and the flow conditions in the core.
In the core as well as above (i.e., at the CET measurement level) a radial temperature profile is always measured (e.g., due to radial core power distribution and additional effects of core barrel and heat losses).
Also at low pressure (i.e., shut down conditions) pronounced delays and temperature differences are measured, which become more important with faster core uncovery and colder upper structures.
Any kind of [accident management] procedures using the CET indication should consider the time delay and the temperature difference of the CET behavior.

I now want to make it clear that: In-Core Thermocouples Would Be Necessary Instead of Core Exit Thermocouples for Signaling the Point to Transition from EOPs to SAMGs.

For clarity, I now repeat my earlier reference to NRC's April 2012 Federal Register notice for a proposed rulemaking. NRC asks stakeholders:
“What is the best approach to ensure that procedural guidance for beyond design basis events is based on sound science, coherent, and integrated? What is the most effective strategy for linking the EOPs with the SAMGs and [Extreme Damage Mitigation Guidelines (“EDMG”)]? Should the transition from EOPs to SAMGs be based on key safety functions, or should the SAMGs be developed in a manner that addresses a series of events that are beyond a plant's design basis?”

As a necessary alternative to relying on CET readings in the event of a severe accident, Nuclear Power Plants (NPP) should operate with in-core thermocouples installed at different elevations and radial positions throughout the reactor core to enable NPP operators to accurately measure a large range of in-core temperatures in NPP steady-state and transient conditions.

Plant operators at both PWRs and BWRs would benefit from relying on in-core thermocouple readings in the event of a severe accident. In such an accident, in-core thermocouples would provide NPP operators with crucial information to enable them track the progression of core damage and manage the accident.

It is clear from the experimental data discussed above that core exit thermocouple measurements would not detect core degradation in a timely manner. The core would be well on the way to a meltdown before core exit temperatures would reach 1200 degrees Fahrenheit. The in-core temperature measurements and the methods of using the measurements for diagnosing the condition of a reactor core in the event of any of a wide spectrum of accidents are the bases of this invention.

The above discussions of severe accidents and the transitions from EOPs to SAMGs are based on relatively slow moving accidents such as the accident at Three Mile Island pressurized water reactor during 1979 and those at the Fukushima boiling water reactors during March 2011. What I mean by relatively slow moving, is that in the above accidents the destructive chemical reactions between the reactor core structures and the water/steam began several hours following the shutdown of the reactors. However, there is no assurance reactor accidents will always be slow moving.

Returning to FIG. 5, the water 16 covers only the lower portion of the reactor core. This is typical of the depiction of slow moving accidents in reports such as the EPRI report “Severe Accident Management Guidance Technical Basis Report, Volume 1: Candidate High-Level Actions and Their Effects and Volume 2: The Physics of Accident Progression”, EPRI TR-101869, Final Report, December 1992. It is also characterized by the Westinghouse analyses that are intended to justify the use of CETs (discussed above).

However, fast moving accidents are possible, and in such cases, the destructive chemical reactions may proceed at substantially higher power levels. In fast moving accidents, the destructive chemical reactions could proceed while the higher power region of the reactor core is covered with water in contrast to the lower water level that is depicted in FIG. 5. This is in contrast to the Westinghouse assertion that the onset of significant core damage as evidenced by the rapid zirconium-water reactions in the core will only occur during the period of time after core uncovery.

With reference to FIG. 6 and FIG. 1, it is clear that an arrangement of several in-core thermocouples 4 at appropriate axial locations within several instrumentation tubes 3 at appropriate radial locations within the nuclear reactor core 1 will provide realistic monitoring of in-core temperatures as the axial power shape changes during the course of an operating cycle that may have a duration of one or more years.

Next, I will address FIG. 7 and FIG. 8. Accidents that became severe at a substantial time after shutdown include the meltdown at Three Mile Island Unit 2 and the meltdowns at the Fukushima nuclear power plants. The procedures to detect and respond to severe accidents that begin within brief times following reactor shutdown are inadequate. Instrumentation such as core exit thermocouples is basically unresponsive to either fast moving or slow moving accidents. Of course, not all accident initiators and durations and consequences are foreseen. However, one set of circumstances is clear; without sufficient cooling, a water cooled nuclear reactor core will incur intense chemical reactions between its metal structures and water/steam. It has been generally assumed that loss of sufficient cooling means that there has been a loss of liquid level. However, there may be accidents in which the reactor fails to completely shut down even though there is a loss of sufficient cooling. For example, a pressurized water reactor could fail to thoroughly shut down following a substantial reduction or a complete loss of circulating water flow. In this case, the reactor core will rapidly overheat and destructive chemical reactions will proceed even though there is no loss of water level and the submerged core exit thermocouples will experience only a very little change in temperature.

In accordance with my method, the output of the in-core thermocouples 4 is directly reported to the operators of the nuclear power plant; FIG. 7. The temperature of each monitored location appears on an appropriate screen. The operators may thus have a continuous awareness of the status of the nuclear reactor core and they may react accordingly in line with established procedures. The operators will also have this vital information available in the event that it becomes necessary to improvise responses to operating conditions, as was the case at several times during the accidents at the Fukushima nuclear power plants. The thermocouple wires are depicted as chromel and alumel, however; this is a general description and it is not intended to limit the specification of the type of thermocouple in this application.

In accordance with another embodiment of my method, the output of the in-core thermocouples 4 is directly reported to monitoring equipment at nuclear power plants, the Customized Safety Parameter Display System (Customized SPDS); FIG. 8. The Customized SPDS has many features of the current Safety Parameter Display Systems that are installed in nuclear power plants in the United States. The Customized SPDS has additional features in accordance with the methods of this invention; features that yield necessary capabilities for monitoring the progress of severe accidents at nuclear power plants.

First I want to describe certain features of the Safety Parameter Display Systems that are in current use in the United States and likely in foreign countries. Applicable regulations of the U. S. Nuclear Regulatory Commission (NRC) include the following:

Each operating reactor shall be provided with a Safety Parameter Display System that is located convenient to the control room operators. This system will continuously display information from which the plant safety status can be readily and reliably assessed by control room personnel who are responsible for the avoidance of degraded and damaged core events.

Following are among the existing required operational displays that are relevant to this invention:

### 312. Reactor Vessel Level

### 313. Core Exit Temperature

Following is a further discussion of these items that is copied from a typical licensing document:

### 312. REACTOR VESSEL LEVEL

This page displays a mimic of the Reactor vessel level, Pressurizer levels and Pressures, and recirculating pump (RCP) status and current are also displayed.

### 313. CORE EXIT TEMPERATURES

This page presents the location and the alarm status of the temperature at the core exit thermocouple locations on a core mimic. Representative core exit temperatures are also included.

The REACTOR VESSEL LEVEL is included here because it has a record of proven ineffectiveness under the accident conditions at Three Mile Island and Fukushima. Furthermore, it is accepted that reactor vessel level measurements are not trustworthy under conditions of rapidly decreasing system pressure such as characterize accidents with large pipe breaks.

The CORE EXIT TEMPERATURES is included here because it is currently (erroneously) employed as a vital factor in determining the onset of the rapid zirconium-steam reaction of the fuel cladding during severe accidents as I have discussed on pages 15, 16 and 17. Thus, on page 15, “Westinghouse's probabilistic risk assessment for the AP1000 states that the core-exit gas temperature (CET) would reach 1200° F. in Time Frame 1, before the onset of the rapid zirconium-steam reaction of the fuel cladding.”

The Customized SPDS has features in accordance with the methods of this invention; features that yield necessary capabilities for monitoring the progress of severe accidents at nuclear power plants. These features are:
1. Measurements from a set of in-core thermocouples.
2. Measurements from a set of in-core local power monitors such as gamma thermometers and/or other means.
3. Recording and archiving items 1 and 2.
4. Applying the archiving of item 2 in determining the nuclear reactor power that arises from decay heating.
5. Specifications for the characteristics of chemical reactions between solid structures of the nuclear reactor core, especially zirconium alloys, and water/steam that are based on experimental data from data from multirod (assembly) severe fuel damage experiments.
6. Calculation of the temperature distribution throughout the core at substantially constant power level operating conditions through the application of physical mathematical models that incorporate items 1, 2, 4 and 5 as well as items from the Customized SPDS that are already state-of-the-art including the rate of reactor coolant flow, reactor coolant temperatures and reactor coolant pressures.
7. Forecasting of the temperature distribution throughout the core in the event of transient conditions, including severe accidents through the application of physical mathematical models that incorporate items 1, 2, 4, 5 and 6, as well as items from the Customized SPDS that are already state-of-the-art including the rate of reactor coolant flow, reactor coolant temperatures and reactor coolant pressures.

The in-core thermocouples measure the temperatures within the nuclear reactor core at known locations. These measurements become a set of calibration points for the mathematical models that calculate the temperature at all locations within the nuclear reactor core. This set of measured real temperatures is used to update the physical mathematical models that calculate the temperatures at all locations within the nuclear reactor core. This means that the set of calculated temperatures at the known locations is continuously compared with the set of measured real temperatures at the known locations. The physical mathematical models are repetitiously adjusted until consistency is obtained between the calculated and measured temperatures at the known locations. The physical mathematical models in the Customized SPDS are thus continuously refined during transient conditions including severe accidents. This aspect of my invention, the continuous refining of the physical mathematical models in the Customized SPDS, reduces the uncertainly in predicting the course of transient conditions including severe accidents.

As stated above, the physical mathematical models are repetitiously adjusted until consistency is obtained between the calculated and measured temperatures at the known locations. However, with several in-core thermocouples, ranging from tens to several hundred, it is highly unlikely that all of the locations would simultaneously achieve a condition of consistency between the calculated and measured temperatures if only one set of physical mathematical models simultaneously serviced the entire set of measured temperatures. Therefore, in accordance with the method of this invention each in-core thermocouple at its assigned location will be aligned with its own set of physical mathematical models. For example if each of the 448 gamma thermometers in the current GE Hitachi system for boiling water reactor cores is modified to include an in-core thermocouple, there will be a distinct physical mathematical model assigned to each in-core thermocouple.

These physical mathematical models will be composed of identical sets of individual modules; however, the weight assigned to individual modules will vary depending on the location of the in-core thermocouple. These models will have substantially identical distributions of the weights of the modules as the nuclear reactor is operated at substantially steady power. The physical mathematical models will be relatively stable and following initial adjustments, only somewhat minor modifications will be effected as the operating cycle proceeds over the course of several months. For example, as illustrated in FIG. 6, the Core Average Axial Power Shape will change during the duration of an operating cycle.

On the other hand, rapid and complex modifications will be effected during accident conditions and these modifications will yield significant changes in the distribution of the weights of the modules as the accident progresses. For example, as partially illustrated in FIG. 5, in an accident scenario in which the reactor core is progressively uncovered as the water level decreases, the related in-core thermocouples will monitor the increasing temperatures. For those locations there will be a shift to an increased weight of modules that apply the characteristics of chemical reactions between solid structures of the nuclear reactor core and water/steam.

There are two basic sets of physical mathematical models. The first set (Set 1) is directed to the characteristics of the nuclear power plant while it is operating at relatively steady power and it is relatively stable. The second set (Set 2) is directed to the characteristics of the nuclear power plant while it is operating under accident conditions that are changing and complex.

The physical mathematical models of Set 1 enable the calculation of temperatures throughout the nuclear reactor core while it is operating at substantially constant power and this includes the water temperatures. In Set 1, the factors including temperature, reactor power, the distribution of reactor power, fluid flow, fluid composition, pressure, composition of the reactor core and the geometry of the reactor core are all relatively unchanging or only very slowly changing during the operating cycle of several months. These physical mathematical models are initially installed based on the design documentation of the nuclear reactor core. These models are then repetitiously adjusted so that consistency is obtained and maintained between the calculated and measured temperatures at the known locations of the in-core thermocouples.

The physical mathematical models of Set 2 enable the calculation of temperatures throughout the nuclear reactor core while it is operating under accident conditions. The physical mathematical models of Set 2 are complex modifications of Set 1. The complexity arises from the impacts of chemical reactions between water and the solid components of the nuclear reactor core as the temperature of the core increases as a consequence of the conditions of the accident. The impacts of the chemical reactions include added thermal power, the production of hydrogen, the oxidation of solid core structures, the change in the geometry of the solid core structures, pressure, and the change in the composition and distribution of the fluid flow. The change in the composition and distribution of the fluid flow arises from the formation of steam, the production of hydrogen, and the change in geometry of the solid core structures. Further complexities arise from the fact that the nuclear power reactor will likely be shut down as the accident proceeds. The temperature measurements by the in-core thermocouples, in combination with the other process measurements and calculations, provide the means for tracking as well as predicting the further course of the accident.

The transition from Set 1 to Set 2 is based on the detection of off-normal operating conditions. For example, a seismic disturbance that leads to reactor shutdown would initiate Set 2 in anticipation of the possibility that related damage could ultimately lead to overheating of the reactor core.

The Customized SPDS with in-core thermocouples will also be a key element in significantly improving the full-scale, state-of-the-art control room simulator of the nuclear power plant. In augmenting the current training practices, the operators of the nuclear power plant will now be trained in the detection off-normal conditions that include the responses of the in-core thermocouples.

As previously described, the Set 1 physical mathematical models of the nuclear power plant's Customized SPDS will be repetitiously adjusted so that consistency is obtained and maintained between the calculated and measured temperatures at the known locations of the in-core thermocouples. Therefore, the current physical mathematical models of Set 1 of the nuclear power plant's customized SPDS will be periodically downloaded to a suitable data storage device and then transferred to the control room simulator. In this manner the control room simulator will periodically updated to represent the current status of the nuclear power plant.

As previously described, the physical mathematical models of Set 2 are complex modifications of Set 1. The complexity arises from the impacts of chemical reactions between water and the solid components of the nuclear reactor core as the temperature of the core increases as a consequence of the conditions of the accident. The complexities of Set 2 are largely based on published laboratory data from multirod (assembly) severe fuel damage experiments. Further laboratory experiments will likely be conducted during the life of the nuclear power plant and the data may be relevant to the Set 2 models. If this situation develops, the Set 2 models may be updated in the customized SPDS of the control room simulator. The performance of the updated Set 2 models may then be evaluated in the control room simulator. If the updated Set 2 models are thus determined to be satisfactory, they may then be downloaded to a suitable data storage device and then transferred to the Customized SPDS of the nuclear power plant. In this manner the Set 2 models of the Customized SPDS may be periodically updated to include the current technology.

The control room simulator with its Customized SPDS having in-core thermocouples will be the key element in training and exercising of the plant operators in the transition from Set 1 to Set 2 conditions as well as the performance under Set 2 conditions.

The training of plant operators on the simulator will also provide exercises for the operators in responding to my method in which the output of the in-core thermocouples 4 is directly reported to the operators of the nuclear power plant; FIG. 7. In these exercises the temperature of each monitored location appears on an appropriate screen. For specific postulated sequences of possible events, the operators may thus have an awareness of the status of the nuclear reactor core and they may respond in accordance with established procedures. In addition, exercises will lead to improved procedures. Exercises may also be designed to challenge an operator to improvise responses.

At this point it is appropriate to include the following quote from the Fukushima Nuclear Accident Analysis Report published by The Tokyo Electric Power Company, Inc., Dec. 2, 2011: To improve safety, for instance, taking into consideration the fact that the reading of the reactor water level gauges greatly differed from the actual value after core damage, it is necessary to have enough diversity rather than simply enhancing the accuracy of the water level gauge. To do this, it is considered that further R&D for measurement devices that meet demands for the accident management is important for further enhancement of the safety.

As an example, if the system of this invention which employs in-core thermocouples in the Customized SPDS had been operational during the accidents at the Fukushima boiling water reactors during March 2011, the reactor operators would have had effective knowledge of the condition of the reactor core as the accident progressed. At Fukushima, emergency cooling of the reactor core was disrupted and the water-covered reactor core gradually lost water. As the water boiled off from the core, the water level dropped, however, the water level gauges did not detect the decrease of water level. If the in-core thermocouples of this invention had been in place at Fukushima, the overheating of the reactor core would have been unambiguously detected as the reactor core was progressively uncovered. With appropriate procedures in place, the reactor operators would have vented the primary containment upon the detection of excessive temperature levels at any region of the reactor core. Thus excessive pressure levels in the primary containment would have been avoided and there would not have been significant leakage of hydrogen into the secondary containment. The detonation of hydrogen and the destruction of the secondary containment would not have occurred.

Furthermore, if certified data from a Customized SPDS at the Fukushima accident was presently available, the current methods of severe accident analysis would be very substantially improved. For example, current methods of severe accident analysis include very seriously erroneous mathematical models for the onset and progression of metal-water reactions and production of hydrogen as a severe accident proceeds at a nuclear power plant. With the significantly corrected methods of severe accident analysis that would be deployed if certified data from a customized SPDS at the Fukushima accidents were available, the worldwide activities in developing procedures for managing severe accidents would be based on sound science.

Timely data on the initiation and progress of the degradation of a nuclear reactor core is provided with the inventor's apparatus and his methods of using of the apparatus regardless of the path of an accident. This in turn enhances the success of an evacuation of the surrounding public which depends on the warning time available.

1. The method for monitoring the condition of a nuclear reactor core comprising:
providing a set of temperature detectors located within the nuclear reactor core,
measuring the temperature at each location,
displaying and analyzing the results of said measurements.

2. The method as defined in claim 1 in which the temperature detectors are thermocouples.

3. The method as defined in claim 2 in which said thermocouples are in combination with local power monitoring units located within and throughout the nuclear reactor core, each local power monitoring unit having an elongated heat conductive body with internal and external surfaces and an array of differential thermocouple devices enclosed within a cavity formed in the body by said internal surface for measuring temperature differentials produced by directional changes in heat flux paths within the body between said internal and external surfaces at a plurality of spaced measurement zones, and having means for in-situ calibration of the power monitoring unit comprising an elongated electrical heater mounted with said array of differential thermocouple devices for measuring temperature differentials within the elongated body, and current supply means connected to the heater externally of the reactor for heating the elongated body through the internal surface thereof at the measurement zones during a calibration period to obtain a calibrating change in signal output from the differential thermocouple devices; said thermocouples are mounted within selected or all of the several local power monitoring units and measure the temperature within the nuclear reactor core at selected or all of several of the local power monitoring units.

4. The method of monitoring a nuclear reactor core while it operates at substantially constant power, comprising the steps of:
(a) measuring the temperature within the nuclear reactor core at each location of a set of fixed locations,
(b) recording and archiving (a),
(c) measuring the local power within the nuclear reactor core at each location of a set of fixed locations,
(d) recording and archiving (c),
(e) calculating the decay heat power at point locations within the core based on (d),
(f) measuring and recording rate of reactor coolant flow,
(g) measuring and recording reactor coolant temperatures,
(h) measuring and recording reactor coolant pressures,
(i) calculating the temperature at point locations throughout the nuclear reactor core based on physical mathematical models that incorporate items (b), (d), (e), (f), (g), and (h) as well the physical description of the nuclear reactor core,
(j) performing step (i) while the nuclear reactor core is operating at steady conditions of local power, total power, reactor coolant flow, reactor coolant temperatures, and reactor coolant pressures,
(k) comparing the measured temperature within the nuclear reactor core at each location of a set of fixed locations with the corresponding calculated temperature each location of that set of fixed locations, and
(l) repetitiously adjusting the physical mathematical models until consistency is obtained between the measured temperature within the nuclear reactor core at each location of a set of fixed locations with the corresponding calculated temperature each location of that set of fixed locations.

5. The method of monitoring a nuclear reactor core while it operates under transient or accident conditions, comprising the steps of:
(a) measuring the temperature within the nuclear reactor core at each location of a set of fixed locations,
(b) recording and archiving (a),
(c) measuring the local power within the nuclear reactor core at each location of a set of fixed locations,
(d) recording and archiving (c),
(e) calculating the decay heat power at point locations within the core based on (d),
(f) measuring and recording rate of reactor coolant flow,
(g) measuring and recording reactor coolant temperatures,
(h) measuring and recording reactor coolant pressures,
(i) calculating the amount of local power at point locations within the reactor core that is produced by chemical reactions between structural components of the of the reactor core and water and/or water-steam mixtures.
(j) calculating the amount of hydrogen at point locations within the reactor core that is produced by chemical reactions between structural components of the reactor core and water and water-steam mixtures.
(k) calculating the temperature at point locations throughout the nuclear reactor core based on physical mathematical models that incorporate items (b), (d), (e), (f), (g), (h), (i) and (j) as well as a postulated changed physical description of the nuclear reactor core under accident conditions,
(l) performing step (k) while the nuclear reactor core is operating at accident conditions of local power, total power, reactor coolant flow, reactor coolant temperatures, and reactor coolant pressures,
(m) comparing the measured temperature at each fixed location within a set of fixed locations throughout the nuclear reactor core with the temperature that is calculated at each corresponding fixed location within a set of fixed locations throughout the nuclear reactor core,
(n) repetitiously adjusting the physical mathematical models of (k) in order to obtain consistency between the measured temperature at each fixed location within a set of fixed locations throughout the nuclear reactor core with the temperature that is calculated at each corresponding fixed location within a set of fixed locations throughout the nuclear reactor core, and
(o) forecasting the progress of the accident by projecting the temperature recording (b) into the future and applying the physical mathematical models (n) in modifying the projected forecast.

6. The method of monitoring a nuclear reactor core wherein the method of claim 4 is shifted to the method of claim 5 upon the detection of off-normal operating conditions.

7. A system for determining the condition of a water cooled nuclear reactor core and monitoring the progress of degradation of a nuclear reactor core during various accidents, comprising:
(a) apparatus for measuring the temperature at a multitude of locations throughout the nuclear reactor core;
(b) apparatus for measuring the local power at a multitude of locations throughout the nuclear reactor core;
(c) apparatus for calculating the temperature distribution throughout the nuclear reactor core;
(d) apparatus for calculating the local power distribution throughout the nuclear reactor core, said local power including;
i) Fission heat,
ii) Decay heat,
iii) Stored heat, and
iv) Chemical reaction heat;
(e) apparatus for calculating the output of chemical reactions between components of the nuclear reactor core and water/steam throughout the reactor core, said output of chemical reactions including;
(i) energy,
ii) temperature of gases,
(iii) composition of gases,
(iv) composition of the components of the nuclear reactor core, and
(v) temperature of the components of the nuclear reactor core.

8. The system of claim 7, wherein the apparatus for measuring the temperature distribution throughout the nuclear reactor core comprises a set of thermocouples.

9. The system of claim 7, wherein the apparatus for measuring the local power distribution throughout the nuclear reactor core comprises a set of self powered neutron detectors.

10. The system of claim 7, wherein the apparatus for measuring the local power distribution throughout the nuclear reactor core comprises a set of gamma thermometers.

11. The system of claim 7, wherein the apparatus for measuring the local power at a set of fixed points throughout the nuclear reactor core comprises a set of gamma thermometers that includes a set of in-core thermocouples that measure local temperatures throughout the nuclear core, said set of in-core thermocouples being integral with the set of gamma thermometers.

12. The system of claim 7, wherein the apparatus for calculating the local power distribution throughout the nuclear reactor core, for calculating the characteristics of chemical reactions between zirconium alloys and water-steam, and for calculating the temperature distribution throughout the nuclear reactor core, is a programmed computer.

13. A system for simulating the condition of a water cooled nuclear reactor core and simulating the progress of degradation of a nuclear reactor core during various accidents, comprising:
(a) apparatus for measuring the temperature within the nuclear reactor core at each location of a set of fixed locations throughout the nuclear reactor core and transferring said set of temperature measurements to a nuclear reactor core simulator;
(b) apparatus for measuring the local power within the nuclear reactor core at each location of a set of fixed locations throughout the nuclear reactor core and transferring said set of local power measurements to a nuclear reactor core simulator;
(c) apparatus for calculating the temperature distribution throughout the nuclear reactor core and transferring said calculations of the temperature distribution throughout the nuclear reactor core to a nuclear reactor core simulator;
(d) apparatus for calculating the local power distribution throughout the nuclear reactor core, and transferring said calculations of the local power distribution throughout the nuclear reactor core to a nuclear reactor core simulator, said local power including;
i) fission heat,
ii) decay heat,
iii) stored heat, and
iv) chemical reaction heat;
(e) apparatus for calculating the output of chemical reactions between components of the nuclear reactor core and water/steam throughout the reactor core, and transferring said calculations of the output of chemical reactions between components of the nuclear reactor core and water/steam throughout the nuclear reactor core to a nuclear reactor core simulator, said calculations of the output of chemical reactions including;
(i) energy,
ii) temperature of gases,
(iii) composition of gases,
(iv) composition of the components of the nuclear reactor core, and
(v) temperature of the components of the nuclear reactor core.

14. The system of claim 13 wherein the transferring of measurements and calculations from the Customized SPDS of the nuclear power plant to the nuclear reactor core simulator via apparatus for this purpose is performed periodically.

15. The system of claim 13 wherein the nuclear reactor core simulator may be employed to predict forthcoming performance.

16. The system of claim 13, wherein the apparatus for measuring the temperature within the nuclear reactor core at each location of a set of fixed locations, comprises a set of thermocouples.

17. The system of claim 13, wherein the apparatus for measuring the local power within the nuclear reactor core at each location of a set of fixed locations, comprises a set of self powered neutron detectors.

18. The system of claim 13, wherein the apparatus for measuring the local power within the nuclear reactor core at each location of a set of fixed locations, comprises a set of gamma thermometers.

19. The system of claim 13, wherein the apparatus for measuring the local power within the nuclear reactor core at each location of a set of fixed locations, comprises a set of gamma thermometers that includes a set of in-core thermocouples that measure local temperatures at the fixed locations of the set of gamma thermometers, said set of in-core thermocouples being integral with the set of gamma thermometers.

20. The system of claim 13, wherein the apparatus for calculating the local power distribution throughout the nuclear reactor core, for calculating the characteristics of chemical reactions between structural components of the of the reactor core and water-steam, and for calculating the temperature distribution throughout the nuclear reactor core, is a programmed computer.
